(19) United States
(12) Patent Application Publication
(10) Pub. No.: US 2009/0317523 A1
(43) Pub. Date: Dec. 24, 2009

(54) METHODS FOR PREPARING FREEZE DRIED FOODS

(75) Inventors: Edward Hirschberg, Hillsborough, CA (US); Zhongli Pan, Davis, CA (US); Tara H. McHugh, El Cerrito, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignees: Innovative Foods Inc., South San Francisco, CA (US); The United States of America, as represented by the Secretary of Agriculture, Washington, DC (US)

(21) Appl. No.: 11/908,785

(22) PCT Filed: Mar. 15, 2006
(86) PCT No.: PCT/US06/09596

§ 371 Date: Jun. 25, 2009

Related U.S. Application Data
(60) Provisional application No. 60/662,474, filed on Mar. 15, 2005.

(51) Int. Cl. A23B 7/024; A23L 1/212; A23B 7/005; A23B 7/00

(52) U.S. Cl. 426/241; 426/385; 426/302; 426/640

(57) ABSTRACT

The present invention relates to a process of manufacturing dried plant products to be used as additives in food. This invention addresses the issue of reducing the cost of freeze-drying plant material while retaining the desired characteristics of the edible plant material.

### CROSS-REFERENCES TO RELATED APPLICATIONS

This application claims priority under 35 USC 119(e) to U.S. Application No. 60/662,474 filed on Mar. 15, 2005, which is incorporated herein by reference.

### BACKGROUND OF THE INVENTION

Dried fruit or vegetables are increasingly popular as snacks or as add-ons in various prepared foods and commercially available meals such as, for instance, soups, casseroles, salads, pasta, rice, cereals, confectionaries, biscuits or snacks.

A variety of methods have been employed to dry plant materials for use in food. For example, WO89/08229 discloses a system and a method for drying granular material by subjecting the granular material to a drying agent, such as nitrogen.

It is also quite common to freeze-dry vegetables. The use of freeze-drying in preserving various types of foods is described in U.S. Pat. No. 4,788,072.

Freeze-drying alone is efficient in maintaining the product texture, but it is a very time and energy consuming drying process making it cost ineffective.

Hot air drying is another drying method that has been used to dry plant materials. This method provides a faster drying rate than freeze-drying, but results in poor product quality where the texture and flavor are generally rated as unacceptable by consumers.

Another common method of drying fruit and vegetables, is sun drying. Sun drying generally results in a product of poor taste.

There is a continuing need for providing dried fruit and vegetable products which are inexpensive, have an appealing taste, aroma and texture, and are nutritious and that are readily consumable as snack foods or readily incorporated into foods such as confectionaries, biscuits, cereals, etc.

The present invention addresses the need for manufacturing dried plant derived products that resemble their fresh counterparts in color, texture, appearance and flavor in a cost effective manner.

### BRIEF SUMMARY OF THE INVENTION

The present invention provides a method of drying plant material, comprising: a) cutting the plant material; b) contacting the cut plant material with a soaking solution thereby preparing coated plant material; c) partially dehydrating the coated plant material thereby preparing partially dehydrated plant material; and d) freeze-drying the partially dehydrated plant material. The cutting step may be optional depending on the size of the fruit. For instance, a berry might not require cutting. In some embodiments, contacting the plant material with a soaking solution may be optional.

In some embodiments, the present invention further comprises the steps of surface freezing the partially dehydrated plant material thereby producing surface frozen plant material; and deep freezing the surface frozen plant material.

Typically, the step of cutting the plant material comprises cutting to a thickness of about 3 mm to about 9 mm.

In some embodiments, the step of contacting is by spraying. In other embodiments, the step of contacting is by immersing. Typically, the soaking solution comprises a sugar solution at about 15° brix to about 30° brix sugar. Alternatively, the soaking solution comprises a fruit puree with 0.5% to 2% calcium, typically 1% calcium. The soaking solution may also comprise 0.5% to 2% ascorbic acid, typically 1% ascorbic acid.

Generally, the step of partially dehydrating removes from about 20% to about 75% water. In some embodiments, the step of partially dehydrating removes from about 45% to about 65% water. In some embodiments, the step of partially dehydrating is carried out by heating the plant material from about 130° F. to 150° F. In other embodiments, the step of partially dehydrating is carried out by exposing the plant material to an infrared heat source. Typically, the step of exposing to infrared heating is carried out at intensities between 3000 and 8000 W/m².

In one aspect, the present invention comprises infrared heating to partially dehydrate and freeze drying to complete the dehydration process and does not include contacting the plant material with a soaking solution.

In some embodiments, the plant material being partially dehydrated is fruit. In some embodiments, the plant material is strawberry. In other embodiments, the plant material is banana. In other embodiments, the plant material is a blueberry. In other embodiments, the plant material is vegetable. In other embodiments, the plant material is an herb.

The present invention provides a dried plant material. In some embodiments, the dried plant material is fruit. In a preferred embodiment, the dried plant material is strawberry. In another preferred embodiment, the dried plant material is banana. In another preferred embodiment, the dried plant material is a blueberry.

### DETAILED DESCRIPTION OF THE INVENTION

### I. Definitions.

“Plant material” as used for the purposes of the present invention refers to edible biological material derived from plants including fruit, vegetables, flowers, leaves, stems, tubers, trunks and herbs.

“Partially dehydrating” as used herein refers to removing moisture from the plant 20 material to a final water content between about 20 and about 75 percent of the original water content in the plant material before processing. Partial dehydration is considered performed when the first signs of shrinkage are noticeable in the plant material.

“Freeze-drying” is understood to mean removing solid water (i.e., ice) from a material by converting it directly into water vapor, skipping the liquid phase entirely.

“Surface freezing” refers to a freezing process where only the surface layer of the material being frozen is at or below 4° C. while the inside of the material being frozen contains water, not ice and is not solid.

“Deep freezing” refers to a freezing process wherein both the surface and the inner layers of the material being frozen are solid and the majority of the water content is turned into ice.

For the purposes of the present invention “dehydrating” refers to removing water from the material wherein the final water content is about ½ to about 7 percent of the original (i.e., prior to any processing described herein) water content in the material.

### II. Introduction.

The present invention relates to a process of manufacturing dried plant products to be used as additives in food.

This invention addresses the issue of reducing the cost of freeze-drying plant material while retaining the desired characteristics of the edible plant material.

### III. Choice of Plant Material.

Any edible plant material can be chosen for the purposes of this invention. In some embodiments, the plant material is a fruit, e.g., but not limited to strawberries, raspberries, blueberries, blackberries, cranberries, bananas, apples, pears, peaches, nectarines, asian pears, kiwi, melon etc. In a preferred embodiment, the fruit is a strawberry.

In some embodiments, the plant material is a vegetable, e.g., but not limited to carrots, peppers, tomatoes, zucchini, potatoes, squash, onions, garlic, fennel, broccoli, cauliflower, etc.

In some embodiments, the plant material is an herb, e.g., parsley, thyme, basil, cilantro, rosemary, bay leaf, mint.

### IV. Slicing the Plant Material.

The methods of the present invention typically include a first step of slicing the plant material unless the plant material is of such a size that it does not lend itself to slicing, e.g., blueberry, raspberry, herb leaves. Either fresh or frozen starting plant materials can be used for slicing. In some embodiments, the plant material can be blanched prior to slicing. Although washing the plant material is not essential for the purposes of the present invention, it can be appreciated by those of skill, that removing debris prior to processing the plant material, is often desirable.

Typically, slicing is performed using an automated slicing machine to achieve consistent slicing thickness. Commonly available machines for this purpose include, for example, Robot Coupe R6X. Typically, the plant material is sliced to a thickness of about 3 to a thickness of about 9 mm. In a preferred embodiment, the plant material is sliced to a thickness of about 6 mm. Alternatively, the plant material can be cut with a commercial crinkle cutter to a thickness of about 9 mm.

Alternatively, slicing may be omitted if the plant material is already of desirable size, e.g., a blueberry, a raspberry, a cranberry, a blackberry, a leaf or a flower.

V. Treating the Plant Material with a Soaking Solution.

After slicing the plant material, the paint material is treated with a soaking solution. Typically, the solution contains about 15 to about 30 degrees brix of sugar. In a preferred embodiment, the solution contains about 20 degrees brix of sugar. In some embodiments, the soaking solution is made by making a simple sugar solution. It can be appreciated by those of skill in the art that a simple sugar solution is made by mixing sugar and water at high heat to allow the sugar to saturate the solution. In some embodiments 0.5% to 2%, more preferably 1%, ascorbic acid can be added to the sugar solution. In some embodiments, the soaking solution can be prepared from high fructose corn syrup, molasses or any other type of sugar-based syrup. In some embodiments, the preservative solution is a fruit puree to which calcium has been added. Typically, calcium is added to a final concentration between 0.5% and 2%. In a preferred embodiment, calcium is added to a final concentration of 1%. 0.5% to 2% ascorbic acid, typically 1% ascorbic acid can also be added to the fruit puree. The fruit puree can be prepared from any fruit. Suitable fruits include: orange, grapefruit, apple, pear, lemon, peach, nectarine, melon, strawberry, raspberry, blueberry or any mixture thereof.

The plant material is treated with the soaking solution by applying the solution to the cut plant material. In some embodiments, the soaking solution can be applied by spraying. The soaking solution can be placed in a spray bottle or can be aerosolized in any way known in the art to allow spraying. Typically, spraying of the soaking solution onto the plant material is done until soaking solution equivalent to 10% of the weight of the material being sprayed is applied. In some embodiments, the soaking solution is applied to the plant material by soaking or immersing the cut plant material into the preservative solution. In a preferred embodiment, the plant material is immersed in the preservative solution from about 10 to about 30 minutes in a large excess of soaking solution. Alternatively, the cut fruit can be left immersed in the soaking solution overnight.

### VI. Partially Dehydrating the Plant Material.

Upon removing the plant material from the soaking solution source, the plant material is partially dehydrated. Partial dehydration involves removing between 20 and 75 percent of the original water content of the plant material. Typically, partial dehydration will remove between 45% and 65% of water from the plant material. It can be appreciated by those of skill in the art that partial dehydration will entail removal of a different percentage of original water content and lead to a different weight decrease depending on the original water and solids content of the particular plant material. A strawberry, for instance, contains about 10% solids and 90% water. Removal of about 50% of the original water weight, will result in about 45% weight reduction. A higher solids content plant material, may contain about 25% solids and 75% water. An about 50% water reduction from the original water content, will result in a weight reduction of about 38%.

Partial dehydration is performed by heating the plant material to about 130° F. to 150° F. and continuing to heat until between about 20 and about 75 percent of the water content is removed from the plant material. In a preferred embodiment, between 45% and 65% of water is removed from the plant material. In some embodiments, partial dehydration is a continuous process. In some embodiments, partial dehydration is perfonned in batch.

Alternatively, the plant material can be exposed to an infrared heat source to partially dehydrate. Similarly to drying by heating through other sources, 20 percent to 75 percent, more preferably 45% to 65% water content reduction is desirable and considered achieved with the first signs of shrinkage of the plant material. For the purposes of this invention, infrared drying can be performed at 3000 to 8000 W/m². Infrared dryers, such as catalytic infrared dryers (CIR) can be used. Because of the penetration capability and thermal energy of infrared radiation, using infrared radiation may also provide blanching function and inactivate enzymes in the fruits and vegetables during the partial dehydration, which could result in improved color (see, e.g., U.S. Patent Application 20060034981.). Additionally, infrared heating contributes to the delay in product spoilage thus increasing the shelf life of the product.

### VII. Freezing and Freeze-Drying.

In some embodiments of the present invention, the partially dehydrated plant material is freeze dried. Freeze-drying is typically performed in a commercial freeze-dryer. Typically, a commercial freeze-dryer, e.g., VirTis Ultra\VirTual Series EL unit will incorporate the steps of surface freezing and deep freezing the plant material prior to initiating the actual freeze-drying step.

In other embodiments, several freezing steps are performed wherein the plant material is first surface frozen. Surface freezing can be performed, for example, by spraying with liquid nitrogen, tumbling with CO₂ snow or with a cold air blast. After surface freezing, the plant material is transferred to a deep freezer and the plant material is allowed to deep freeze. The deep freezing step can be performed in a IQ quick freezing tunnel. Alternatively, deep freezing can be performed in a sub zero freezer or room. Typically, deep freezing is allowed to proceed overnight. The surface freezing and deep freezing steps are then followed by freeze-drying.

### VIII. The Dehydrated Plant Material Product.

The methods of this invention address the need for a dried plant material that can be added to a variety of foods such as, for instance, soups, casseroles, salads, pasta, rice, cereals, confectionaries, biscuits or snacks in a cost effective manner and while preserving the appearance, texture and flavor of the plant material's fresh counterpart.

### Examples

### Example 1

### Dehydrating Strawberry Slices—Control Run not Involving Treatment with Preservative Solution

Fresh strawberries were first cut to 6 mm thickness using a Robot Coupe R6X slicer. The strawberry slices were individually layered on plastic racks at 227 grams of sliced strawberries per square foot. The racks containing the strawberry slices were then transferred to a food dehydrator set to a temperature of 150° F. After one hour, the weight was reduced from a total of 1567 grams to 822 grams corresponding to a 48% weight reduction. The racks of now partially dehydrated strawberries were then deep frozen followed by freeze drying in a commercial freeze-dryer to a final weight of 141 grams.

### Example 2

### Time Checks for Moisture Reduction at 153° F.

Starting at 637 grams at 153° F., the following moisture reductions were recorded:

| | | |
|---|---|---|
| 30 minutes | 452 grams | 30% weight loss |
| 45 minutes | 376 grams | 41% weight loss |
| 60 minutes | 301 grams | 53% weight loss |

### Example 3

### Drying Strawberries Including Immersing in 30° Brix Sugar Solution

312 grams of sliced strawberries were immersed in a 30° brix sugar solution (Staley Dex 333) for 2 minutes. The immersion resulted in a weight increase to 400 grams. The strawberries were subsequently dried as described in Example 1. The dried strawberries weighed 43 grams resulting in a 19% weight increase from the control.

### Example 4

### Drying Strawberries Including Spraying with 30° Brix Sugar Solution

343 grams of sliced strawberries were sprayed with 30° brix sugar solution (Staley Dex 333) increasing weight to 400 grams. Upon drying as described in Example 1 the weight of the final dried product increased to 10% above the control.

### Example 5

### Study of Banana Dehydration Using Sequential Infrared Radiation and Freeze-Drying

Cavendish bananas at color stage #6 were first peeled and sliced into 5 mm thickness slices. The slices were dried using a catalytic infrared (CIR) dryer to target 20%, 30%, and 40% weight reductions as predehydration under each of the three radiation intensities, 3000, 4000, and 5000 W/m². The pre-dehydrated banana slices were then frozen and dried with a freeze-dryer (VirTis Ultra\VirTual Series EL unit) to achieve a final moisture content of about 5%. The drying times and rates of SIRFD with different processing conditions were measured and the quality of finished products was evaluated. The drying characteristics were modeled to determine the drying behaviors during SIRFD.

The table below shows the times for banana slices to achieve the different weight reductions under infrared radiation as pre-dehydration. The results showed that the required drying times were reduced with the increased of infrared intensity. The 20% weight reduction of the banana slices were achieved with 7, 6, and 4 minutes under 3000, 4000, and 5000 W/m² intensity, respectively.

Results of SIRFD

| Radiation Intensity | Weight Reduction | Time Required |
|---|---|---|
| (W/m²) | (%) | (min) |
| 3000 | 20 | 7 |
| | 30 | 11 |
| | 40 | 15 |
| 4000 | 20 | 6 |
| | 30 | 9 |
| | 40 | 14 |
| 5000 | 20 | 3.5 |
| | 30 | 5 |
| | 40 | 7 |

### Example 6

### Drying Strawberry Slices Using Sequential Infrared Radiation and Freeze Drying

Strawberry slices of 4 mm thickness were dried using a catalytic infrared (CIR) dryer to achieve 30%, 40%, and 50% moisture removal under each of the three radiation intensities, 3000, 4000, and 5000 W/m². Then the pre-dehydrated strawberry slices were frozen and dried with a freeze dryer to achieve a final moisture content of about 5%. The drying times and rates of SIRFD with different processing conditions were measured and the quality of finished products was evaluated. The results showed that infrared drying alone could remove 30% of moisture in 6, 5, and 4 minutes with 3000, 4000, and 5000 W/m² intensity, respectively. Additionally, the SIRFD method could significantly reduce the overall drying time and produce high quality product compared to regular freeze-drying. Because of reduced drying time, the SIRFD method showed great energy saving potential for drying fruits and vegetables.

It is understood that the examples and embodiments described herein are for illustrative purposes only and that various modifications or changes in light thereof will be suggested to persons skilled in the art and are to be included within the spirit and purview of this application and scope of the appended claims. All publications, patents, and patent applications cited herein are hereby incorporated by reference for all purposes.

What is claimed is:

1. A method of drying plant material, comprising:
a) contacting the plant material with a soaking solution thereby preparing coated plant material;
b) partially dehydrating the coated plant material thereby preparing partially dehydrated plant material; and
c) freeze-drying the partially dehydrated plant material.

2. The method of claim 1 further comprising the step of cutting the plant material.

3. The method of claim 1 further comprising the step of surface freezing the partially dehydrated plant material.

4. The method of claim 1 further comprising the step of deep freezing the partially dehydrated plant material.

5. The method of claim 1 further comprising:
a) surface freezing the partially dehydrated plant material thereby producing surface frozen plant material; and
b) deep freezing the surface frozen plant material.

6. The method of claim 1 wherein the step of cutting the plant material comprises cutting to a thickness of about 3 mm to about 9 mm.

7. The method of claim 1 wherein the contacting step is carried out by spraying.

8. The method of claim 1 wherein the contacting step is carried out by immersing.

9. The method of claim 1 wherein the soaking solution comprises a sugar solution at about 15° brix to about 30° brix.

10. The method of claim 1 wherein the soaking solution comprises a fruit puree and calcium.

11. The method of claim 10 wherein the soaking solution comprises 1% calcium.

12. The method of claim 10 wherein the soaking solution comprises from about 15° brix to about 30° brix sugar.

13. The method of claim 1 wherein the step of partially dehydrating removes from about 20% to about 75% of water.

14. The method of claim 1 wherein the plant material is fruit.

15. The method of claim 1 wherein the plant material is strawberry.

16. The method of claim 1 wherein the plant material is banana.

17. The method of claim 1 wherein the plant material is vegetable.

18. The method of claim 1 wherein the step of partially dehydrating is carried out by heating the plant material from about 130° F. to 150° F.

19. The method of claim 1 wherein the step of partially dehydrating is carried out by exposing plant material to an infrared heat source.

20. The method of claim 19 wherein exposure to infrared heating is carried out at intensities between 3000 and 8000 W/m².

21. A dried fruit product made by the method of claim 1.

22. The dried fruit product of claim 21 wherein the dried fruit product is strawberry.

23. The dried fruit product of claim 21 wherein the dried fruit product is banana.

24. The dried fruit product of claim 1 wherein the dried fruit product is a blueberry.
